(19) United States
(12) Patent Application Publication
(10) Pub. No.: US 2019/0158551 A1
(43) Pub. Date: May 23, 2019

(54) TRANSMISSION DEVICE, RECEIVING DEVICE, COMMUNICATION SYSTEM, AND COMPUTER PROGRAM PRODUCT

(71) Applicants: Kabushiki Kaisha Toshiba, Minato-ku (JP); Toshiba Infrastructure Systems & Solutions Corporation, Kawasaki-shi (JP)

(72) Inventors: Takumi Kurosaka, Kawasaki (JP); Shunichi Gondo, Ota (JP); Hideki Ueno, Urayasu (JP)

(73) Assignees: Kabushiki Kaisha Toshiba, Minato-ku (JP); Toshiba Infrastructure Systems & Solutions Corporation, Kawasaki-shi (JP)

(21) Appl. No.: 15/907,333

(22) Filed: Feb. 28, 2018

(30) Foreign Application Priority Data
Nov. 17, 2017 (JP) 2017-221452

(51) Int. Cl. H04L 29/06

(52) U.S. Cl. CPC H04L 65/4084; H04L 67/42

(57) ABSTRACT

According to an embodiment, a transmission device includes a first sending unit and a second sending unit. The first sending unit is configured to send, to a receiving device, one or more pieces of identification information identifying one or more pieces of transmission data. The second sending unit is configured to send, to the receiving device, determination information meant for determining whether or not to request transmission of the transmission data identified by the identification information.

### CROSS-REFERENCE TO RELATED APPLICATIONS

This application is based upon and claims the benefit of priority from Japanese Patent Application No. 2017-221452, filed on Nov. 17, 2017; the entire contents of which are incorporated herein by reference.

### FIELD

Embodiments described herein relate generally to a transmission device, a receiving device, a communication system, and a computer program product.

### BACKGROUND

In the adaptive streaming such as HTTP Live Streaming (HLS) or Moving Picture Experts Group-Dynamic Adaptive Streaming over HTTP (MPEG-DASH); a contents distributor generates a distribution list related to contents (a group of contents) to be distributed (i.e., generates a contents distribution list), and distributes the distribution list a contents receiver. Usually, the contents distributor writes metadata, such as the destinations of the contents and the bitrates, in the distribution list. The contents receiver obtains and analyzes the distribution list so as to become able to identify the contents to be received.

### BRIEF DESCRIPTION OF THE DRAWINGS

FIG. 1 is a diagram illustrating an overall configuration of a communication system according to an embodiment;

FIG. 2 is a functional block diagram of a distribution server and a client;

FIG. 3 is a diagram illustrating an exemplary data structure of a distribution list;

FIG. 4 is a diagram illustrating an exemplary data structure of determination information;

FIG. 5 is a flowchart for explaining a list generation operation according to the embodiment;

FIG. 6 is a flowchart for explaining a determination information generation operation according to the embodiment;

FIG. 7 is a sequence diagram illustrating a contents distribution operation according to the embodiment;

FIG. 8 is a diagram for explaining an example in which determination is performed with respect to the distribution list using the determination information;

FIG. 9 is a diagram illustrating an example of updated determination information;

FIG. 10 is a diagram for explaining an example in which determination is performed with respect to the distribution list using the determination information;

FIG. 11 is a diagram illustrating a data structure of the distribution list according to a first modification example and is a diagram for explaining an example of performing determination;

FIG. 12 is a diagram for explaining an example in which determination is performed with respect to the distribution list using the determination information;

FIG. 13 is a diagram for explaining an example in which only some of the determination information is sent and determination is accordingly performed;

FIG. 14 is a diagram for explaining an example in which only some part of the distribution list is sent and determination is accordingly performed; and

FIG. 15 is a hardware configuration diagram of the devices according to the embodiment.

### DETAILED DESCRIPTION

In general, according to an embodiment, a transmission device includes a first sending unit and a second sending unit. The first sending unit is configured to send, to a receiving device, one or more pieces of identification information identifying one or more pieces of transmission data. The second sending unit is configured to send, to the receiving device, determination information meant for determining whether or not to request transmission of the transmission data identified by the identification information.

A preferred embodiment of a communication system is described below in detail with reference to the accompanying drawings. The following explanation is given about a communication system that includes a distribution server (an example of a transmission device), which distributes contents such as video data (an example of transmission data), and a client tan example of a receiving device), which receives contents. However, the applicable communication system is not limited to the example given above; and a communication system that transmits and receives any type of transmission data can be considered.

As described earlier, when the contents distributor updates a distribution list, there are times when the contents receiver cannot efficiently identify the updated points. Thus, for example, in order to obtain the latest distribution list, the contents receiver needs to re-obtain the distribution list from the contents distributor and reanalyze the distribution list, thereby resulting in unnecessary processing.

Examples of updating a distribution list include a case in which, from among a plurality of contents planned for transmission, some contents change from the non-transmittable state to the transmittable state. For example, there is a case in which, from the entire video data, some midstream video data that is in the non-transmittable state due to some reason changes to the transmittable state.

In such a case, as a method of updating the distribution list, it is possible to think of a method in which the contents distributor adds new updated information midway through the distribution list and updates the distribution list. The contents receiver re-obtains some part of the distribution list from the beginning and re-analyzes the obtained part; and, until the newly-updated portion is identified, repeatedly performs re-obtaining and reanalysis of some part of the distribution list. However, for example, if an already-analyzed portion is newly updated, then there is a change in the position of writing of that portion in the distribution list. Hence, the contents receiver needs to again re-obtain and reanalyze some part of the distribution list from the beginning, thereby resulting in unnecessary processing.

As another method of updating the distribution list, it is possible to think of a method in which the contents distributor adds new updated information at the end of the distribution list. Thus, if the contents receiver obtains only the difference with the already-obtained portion in the distribution list, it becomes possible to obtain only the updated information of the distribution list. However, since it becomes necessary to merge the analysis result of the updated portion with the already-analyzed information, this method happens to be inefficient.

The transmission device according to the embodiment generates a distribution list that also includes the contents associated to the information which is likely to be updated, as well as generates determination information that enables determination about whether or not the contents are transmittable; and sends the distribution list and the determination information to the receiving device. Then, using the distribution list and the determination information received from the transmission device, the receiving device determines the contents requested for transmission. When some information is updated, the transmission device again generates the determination information and sends it to the receiving device.

With such a configuration, for example, the distribution list need not be sent every time there is updating. Moreover, by referring to the determination information, the updated points can be easily analyzed. Thus, without having to re-obtain and reanalyze the distribution list, the information equivalent to the latest distribution list can be obtained and analyzed with efficiency.

Given below is the explanation of an example of the transmission data applicable in the embodiment. For example, the transmission data contains time-series data, such as video data and sensor data, in which the chronological sequence is fixed.

The video data is obtained by, for example, imaging performed by an imaging device such as a camera. For example, the video data is obtained from the imaging device in real time, and is used as the target contents for distribution. Herein, video data that was obtained by imaging and that has been temporarily stored in a memory medium can also be used as the target contents for distribution.

The sensor data represents data indicating the values detected by a sensor (a detecting device) and contains, for example, the information about the timings of data detection. Herein, the sensor can be any type of device. For example, it is possible to use a sensor that detects, either regularly or irregularly, the temperature, the velocity, and the pressure of an electronic device representing the detection target; and outputs sensor data.

Meanwhile, the transmission data (contents) written in a distribution list can be in any arbitrary unit. In the case of distributing video data, the video data partitioned at arbitrary intervals or at regular intervals can be treated as the unit. Alternatively, a chunk of predetermined contents, such as one or more frames, can be treated as the unit; and the contents can be listed in distribution list. In the case of distributing the sensor data, the sensor data obtained at each timing can be treated as the unit, or the sensor data partitioned at arbitrary intervals or regular intervals including one or more timings can be treated as the unit.

In the configuration in which time-series data is distributed, due to some reason, there can be times when the midstream data cannot be treated as the distribution target (i.e., there occurs data loss). For example, in a configuration in which video data captured by an imaging device is obtained and distributed at the same time, in case the communication between the transmission device and the imaging device gets temporarily disconnected, it may result in a situation in which the midstream data cannot be obtained and cannot be immediately distributed. Meanwhile, if the connection for communication is restored, then it becomes possible to obtain the midstream data that could not be obtained. For example, it is possible to have a configuration in which, when there is an instruction for rewinding and reproduction, then the entire video data including the obtained midstream data is reproduced.

In the embodiment, in such a case too, the distribution list including the midstream data sent in advance, as well as determination information enabling identification of whether or not the transmission data is transmittable is sent. As a result, for example, when the midstream data can be obtained, the distribution list need not be sent again.

Meanwhile, the transmission data is not limited to be time-series data. That is, the embodiment can also be applied to such data from which the entire transmission data representing the distribution target can be known in advance but some of that transmission data becomes untreatable as the distribution target (i.e., there occurs data loss).

For example, the embodiment can be applied even in the case in which a plurality of pieces of transmission data is uploaded to the transmission device and is then distributed to a different receiving device. At the point of time of instructing the uploading of a plurality of pieces of transmission data, the entire transmission data representing the distribution target can be known. On the other hand, depending on the status of communication meant for the uploading purpose, some pieces of transmission data sometimes get delayed as compared to other pieces of transmission data.

In the embodiment, in such a case too, for example, regardless of whether or not the uploading is completed, a distribution list including all pieces of transmission data can be sent as well as the determination information enabling determination of whether or not the transmission data is transmittable (whether or not the distribution of the uploaded transmission data is receivable) can be sent. As a result, the receiving device that receives the distribution of the transmission data becomes able to determine the pieces of transmission data in the distribution receivable state. Moreover, for example, when the uploading is completed, the distribution list need not be sent again.

The transmission data need not be already-obtained data and, for example, can be data that is expected to be obtained in future (i.e., future data). In the distribution list, the transmission data representing the distribution target can be specified using future timings (a range of timings). In that case, for example, at a specified timing, when the transmission data is obtained, determination information indicating that the transmission data has become transmittable gets generated.

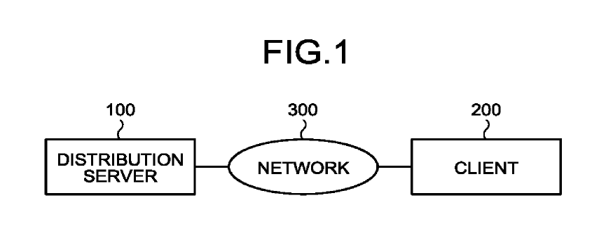

FIG. 1 is a diagram illustrating an exemplary overall configuration of the communication system according to the embodiment. As illustrated in FIG. 1, the communication system according to the embodiment includes a distribution server 100 representing a transmission device and includes a client 200 representing a receiving device. The distribution server 100 and the client 200 are connected to each other via a network 300 such as the Internet.

The distribution server 100 distributes a distribution list and determination information via the network 300. The contents listed in the distribution list not only include the contents in the transmittable state but can also include the contents in the non-transmittable state and the contents not allowed to be transmitted. The determination information enables the receiving device (the client 200) to determine whether or not to request transmission of the contents listed in the distribution list.

The client 200 receives the distribution list and the determination information from the distribution server 100; analyzes the distribution list using the determination information; and obtains information required in receiving the distribution of the contents.

The configuration of the communication system as illustrated in FIG. 1 is only exemplary, and is not limited to that example. Alternatively, for example, it is possible to have a plurality of distribution servers 100 and a plurality of clients 200. Moreover, one or more contents providing devices that are meant for providing the contents distributed by the distribution server 100 (for example, an imaging device meant for providing image data) can also be included. Meanwhile, the distribution server 100 as well as the client 200 can be configured either using a single physical device or using a plurality of physical devices. Alternatively, for example, the distribution server 100 can be built in the cloud environment.

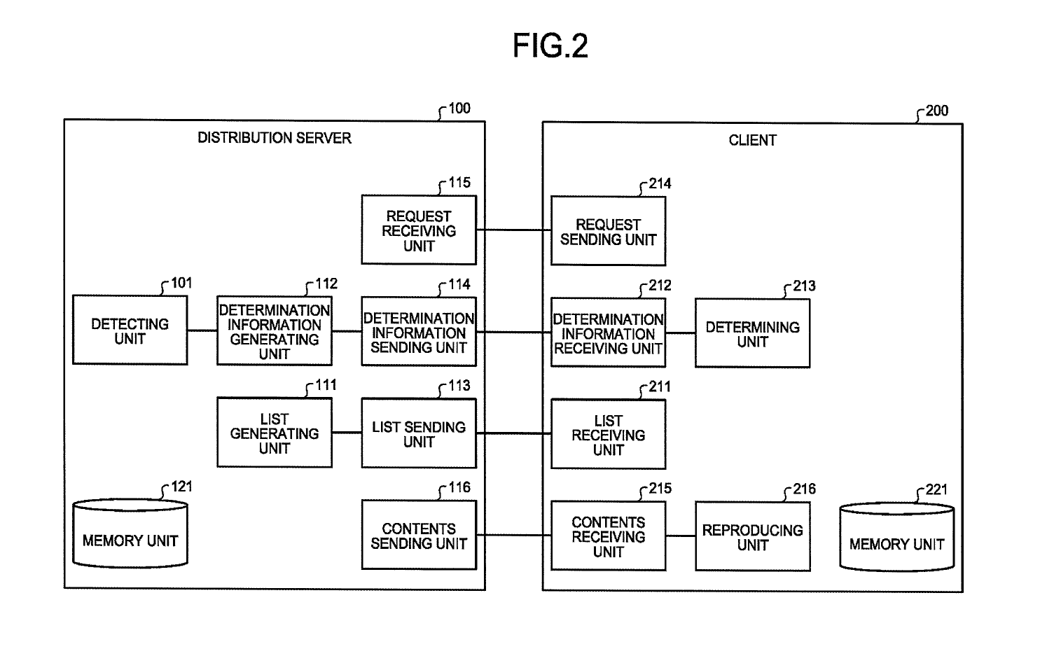

FIG. 2 is a block diagram illustrating an exemplary functional configuration of the distribution server 100 and the client 200. As illustrated in FIG. 2, the distribution server 100 includes a detecting unit 101, a list generating unit 111, a determination information generating unit 112, a list sending unit 1 first sending unit), a determination information sending unit 114 (a second sending unit), a request receiving unit 115, a contents sending unit 116 third sending unit), and a memory unit 121.

The detecting unit 101 detects that the contents have become transmittable. For example, when the contents are provided from a providing unit that provides contents, the detecting unit 101 determines that the contents have become transmittable. Alternatively, the detecting unit 101 can monitor the memory area (for example, the memory unit 121) in which the contents are stored, and can determine that the contents have become transmittable when the contents get stored.

The list generating unit 111 generates a distribution list. For example, when the client 200 requests for generation and transmission of a distribution list, the list generating unit 111 generates a distribution list. However, that is not the only possible trigger for the generation of a distribution list, and any other trigger can also be used. For example, every time a certain period of time elapses, the list generating unit 111 can generate a distribution list the contents to be sent during the next period of time. Alternatively, when the contents are provided from a providing device or when a generation instruction is issued, the list generating unit 111 can generate a distribution list.

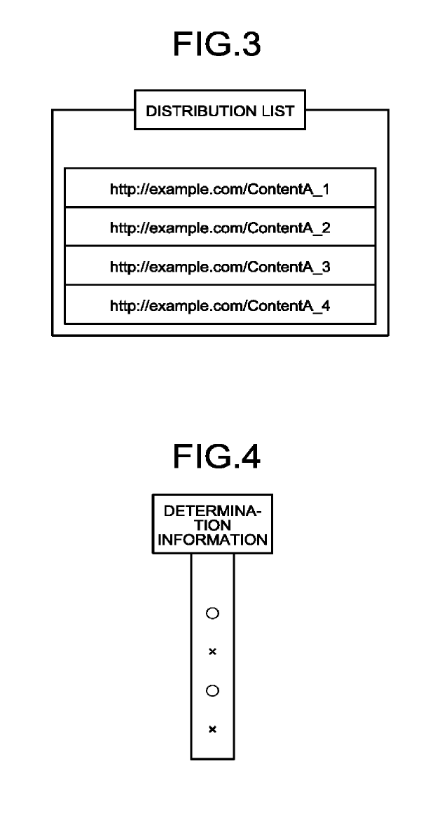

FIG. 3 is a diagram illustrating an exemplary data structure of a distribution list. As illustrated in FIG. 3, the distribution list includes identification information that enables identification of the contents. In FIG. 3 is illustrated an example in which the Uniform Resource Locators (URLs) of the contents are used as the identification information. As long as the contents become identifiable, other identification information other than URLs can also be used. Moreover, the distribution list can also include information other than the identification information.

Returning to the explanation with reference to FIG. 2, the determination information generating unit 112 generates determination information. For example, when the contents are transmittable, the determination information generating unit 112 generates determination information indicating that contents are transmittable; and, when the contents are not transmittable, the determination information generating unit 112 generates determination information indicating that contents are not transmittable. Moreover, when there is a change in e situation indicating whether or not the contents are transmittable, the determination information generating unit 112 generates determination information that is updated corresponding to the changed situation.

For example, when the client 200 requests for generation and transmission of determination information, the determination information generating unit 112 generates determination information. When the list generating unit 111 generates a distribution list, the determination information generating unit 112 can generate the determination information for that point of time. However, that is not the only possible trigger for the generation of determination information, and any other trigger can also be used. For example, every time a certain period of time elapses, the determination information generating unit 112 can use, for example, the detecting unit 101 to detect whether or not the contents have become transmittable and can generate updated determination information according to the detection result.

FIG. 4 is a diagram illustrating an exemplary data structure of the determination information. The determination information illustrated in FIG. 4 is an example of determination information meant for determining whether or not the four types of contents listed in the distribution list illustrated in FIG. 3 are transmittable. For example, “∘” indicates that the corresponding content is transmittable, while “×” indicates that the corresponding content is transmittable. In the example illustrated in FIG. 4, corresponding to the four contents associated to the four URLs illustrated in FIG. 3 (i.e., “ContentA_1”, “Content_2”, “ContentA_3”, and “ContentA_4”), four pieces of determination information (“∘” or “×”) are specified in the corresponding sequence.

If a method is available for enabling specification of determination information on a contents-by-contents basis, then it is possible to use determination information having some other data structure than the data structure illustrated in FIG. 4. For example, the identification information of the contents can be associated to the determination information. Alternatively, in order to enable identification of the distribution list to which the determination information corresponds, information enabling identification of the distribution list can be associated to the determination information.

Herein, the transmittable state of contents implies the state in which, for example, the target contents for distribution have been provided to the distribution server 100 and are transmittable to the client 200. The non-transmittable state of contents implies the state in which, for example, the target contents for distribution have not been provided to the distribution server 100 and are not transmittable to the client 200. Meanwhile, the distribution server 100 can send the contents in response to a request from the client 200 (pull-type transmission), or can send the contents without receiving a request from the client 200 (push-type transmission).

Regardless of whether or not contents have been provided, the distribution server 100 can specify whether or not the contents are transmittable. For example, the configuration can be such that, in order to reduce the communication load, with respect to some or all of a plurality of provided contents, determination information indicating that the contents are not transmittable is generated so that the contents cannot be transmitted. In this way, there can be times when the transmittable contents later become non-transmittable.

For each content, there can be a single piece of determination information or there can be a plurality of pieces of determination information. For example, one or more pieces of metadata of the content can be used as the determination information. Examples of the metadata include range information indicating the range of the content, the data length of the content, and the type of the content. The range information is used to specify the range of the data to be distributed as the content. When the range information is finalized, the finalized range information is set as the determination information. When the range information is not finalized, predetermined information indicating non-finalization (non-finalized information) is set as the determination information. When non-finalized information is set in the range information representing the determination information, the client 200 becomes able to determine that the corresponding content is non-transmittable. Thus, when metadata is used as the determination information, such a data format can be set by which it becomes possible to determine using the metadata about whether or not the content is transmittable.

Returning to the explanation with reference to FIG. 2, the list sending unit 113 sends the distribution list, which is generated by the list generating unit 111, to the client 200. For example, before the start of transmission of the contents, the list sending unit 113 sends the distribution list in advance to the client 200. The determination information sending unit 114 sends determination information, which is generated by the determination information generating unit 112, to the client 200.

The request receiving unit 115 receives various requests from the client 200. For example, from the client 200, the request receiving unit 115 receives a transmission request for sending the distribution list, a transmission request for sending the determination information, and a transmission request for sending contents.

The contents sending unit 116 sends the requested contents to the client 200 that issued a transmission request. In the case of implementing push-type transmission, the contents sending unit 116 can send the contents without receiving a request from the client 200.

The memory unit 121 is used to store a variety of data used in the distribution server 100. For example, the memory unit 121 is used to store the target contents for distribution, the generated distribution list, and the generated determination information.

Meanwhile, the abovementioned constituent elements (the detecting unit 101, the list generating unit 111, the termination information generating unit 112, the list sending unit 113, the determination information sending unit 114, the request receiving unit 115, and the contents sending unit 116) are implemented using, for example, one or more processors. For example, the abovementioned constituent elements can be implemented by making a processor such as a central processing unit (CPU) execute computer programs, that is, can be implemented using software. Alternatively, the abovementioned constituent elements can be implemented using a processor such as a dedicated integrated circuit (IC), that is, can be implemented using hardware. Still alternatively, the abovementioned constituent elements can be implemented using a combination of software and hardware. In the case of using a plurality of processors, each processor either can implement one of the constituent elements or can implement two or more constituent elements.

Moreover, the functions of the distribution server 100 can be deconcentrated across a plurality of physically-different devices or a plurality of logically-different devices. For example, the distribution server 100 can be divided into a server device for sending the distribution list and a server device for sending the contents

Given below is the explanation of the functions of the client 200. As illustrated in FIG. 2, the client 200 includes a list receiving unit 211 (a first receiving unit), a determination information receiving unit 212 (a second receiving unit), a determining unit 213, a request sending unit 214, a contents receiving unit 215 (a third receiving unit), a reproducing unit 216, and a memory unit 221.

The list receiving unit 211 receives a distribution list from the distribution server 100. The determination information receiving unit 212 receives determination information from the distribution server 100.

The determining unit 213 determines, based on the distribution list and the determination information, the contents to be requested for transmission. For example, from among the contents having the URLs specified in the distribution list illustrated in FIG. 3, the determining unit 213 determines, as the contents to be requested for transmission, the contents for which “∘” is set as the determination information as illustrated in FIG. 4. In the case of using the range information as the determination information, for example, the determining unit 213 determines, as the contents to be requested for transmission, the contents for which non-finalized information is not set in the range information. In the case of using a plurality of pieces of determination information, the determining unit 213 can determine the contents to be requested for transmission according to the combination of the pieces of determination information. For example, when all pieces of determination information indicate that a particular content is transmittable, then the determining unit 213 determines that particular content as the content to be requested for transmission.

The request sending unit 214 sends, to the distribution server 100, a transmission request for sending the contents that are determined to be requested for transmission. The contents receiving unit 215 receives, from the distribution server 100, the contents sent in response to the transmission request issued by the request sending unit 214. The reproducing unit 216 reproduces the received contents.

The memory unit 221 is used to store a variety of data used in the client 200. For example, the memory unit 221 is used to store the received distribution list, the received determination information, and the distributed contents.

Meanwhile, the abovementioned constituent elements (the list receiving unit 211, the determination information receiving unit 212, the determining unit 213, the request sending unit 214, the contents receiving unit 215, and the reproducing unit 216) are implemented using, for example, one or more processors. For example, the abovementioned constituent elements can be implemented by making a processor such as a CPU execute computer programs, that is, can be implemented using software. Alternatively, the abovementioned constituent elements can be implemented using a processor such as a dedicated IC, that is, can be implemented using hardware. Still alternatively, the abovementioned constituent elements can be implemented using a combination of software and hardware. In the case of using a plurality of processors, each processor either can implement one of the constituent elements or can implement two or more constituent elements.

Each memory unit (each of the memory units 121 and 221) can be configured using any type of commonly-used memory medium such as a hard disk drive (HDD), an optical disk, a memory card, or a random access memory (RAM). Alternatively, each memory unit can be implemented using a plurality of physically-different memory mediums.

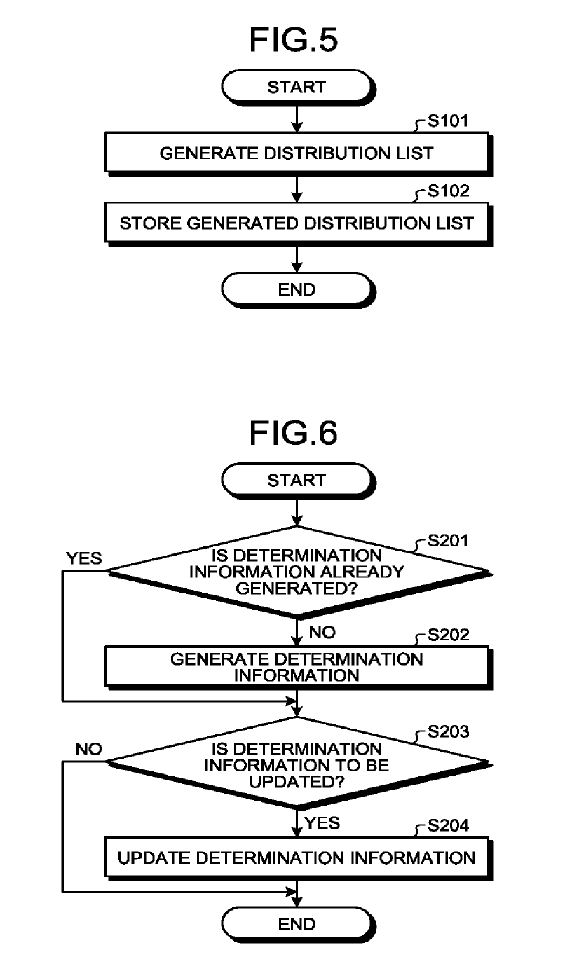

Given below is the explanation of a list generation operation performed in the distribution server 100 that is configured in the abovementioned manner according to the embodiment. The list generation operation is performed by the distribution server 100 to generate a distribution list. FIG. 5 is a flowchart for explaining an example of the list generation operation according to the embodiment.

For example, in response to a request from the client 200, the list generating unit 111 in the distribution server 100 generates a distribution list (Step S101). Then, the list generating unit ill stores the generated distribution list in the memory unit 121 (Step S102).

As an example, assume that temporally-continuous contents ContentA_1, ContentA_2, ContentA_3, and ContentA_4 are present as the contents expected to be distributed and assume that the contents ContentA_1 and ContentA_3 are distributable. In this case, the list generating unit 111 generates a distribution list related to the distribution of the contents ContentA_1, ContentA_2, ContentA_3, and ContentA_4. In FIG. 3 is illustrated an example of the distribution list generated in this case.

Given below is the explanation of a determination information generation operation performed in the distribution server 100 according to the embodiment. The determination information generation operation is performed by the distribution server 100 to generate determination information. For example, the determination information generation operation is performed in response to a transmission request issued by the client 200 for sending determination information. FIG. 6 is a flowchart for explaining an example of the determination information generation operation according to the embodiment.

In the distribution server 100, the determination information generating unit 112 determines whether or not determination information has already been generated regarding the contents expected to be distributed (Step S201). If the determination information is not yet generated (No at Step S201), then the determination information generating unit 112 generates the determination information for the concerned contents (Step S202). In FIG. 4 is illustrated an example of the determination information that is generated regarding the example explained with reference to FIG. 5 (i.e., the example in which the contents ContentA_1 and ContentA_3 are distributable).

After the determination information is generated or when the determination information has already been generated (Yes at Step S201), the determination information generating unit 112 determines whether or not to update the already-generated determination information (Step S203). For example, when a detection result indicating that the contents have become transmittable is received from the detecting unit 101, the determination information generating unit 112 determines to update the determination information.

When it is determined to update the determination information (Yes at Step S203), the determination information generating unit 112 updates the determination information (Step S204). After the determination information is updated or if it is determined not to update the determination information (No at Step S203), it marks the end of the determination information generation operation.

The distribution server 100 sets the generated distribution list and the generated determination information in the distributable state via the network 300. Thus, the client 200 can obtain the distribution list and the determination information by accessing the distribution server 100.

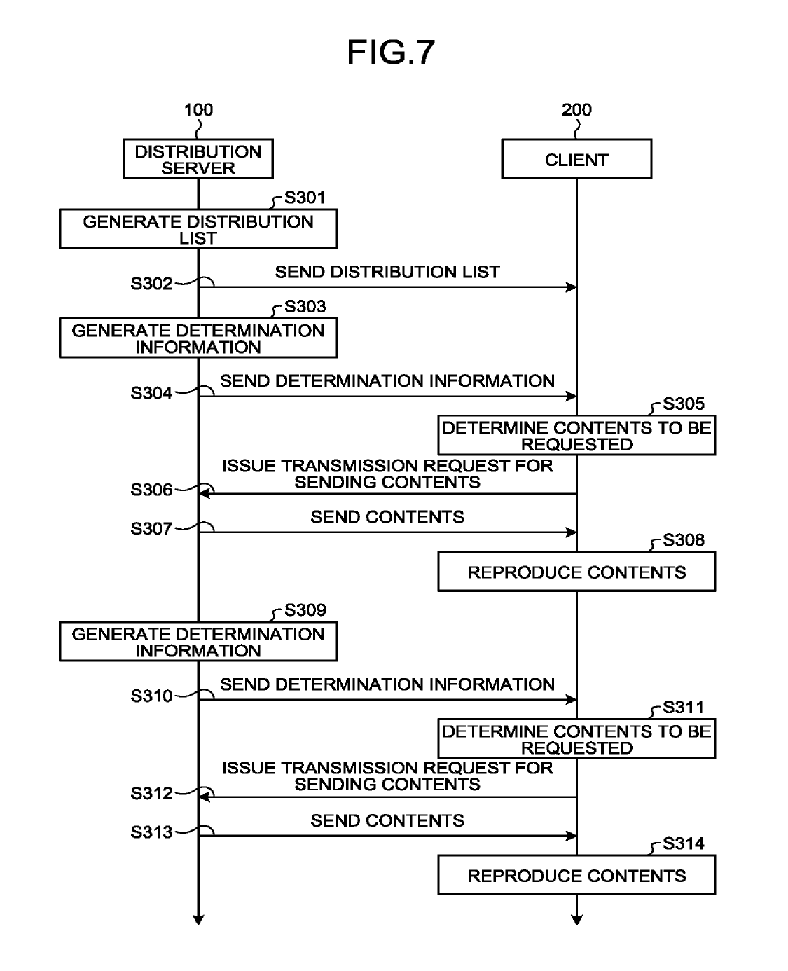

Given below is the explanation of a contents distribution operation performed in the communication system according to the embodiment. FIG. 7 is a sequence diagram illustrating an example of the contents distribution operation according to the embodiment.

In the distribution server 100, the list generating unit 111 generates a distribution list (Step S301). This operation is equivalent to, for example, the list generation operation described earlier. Then, in the distribution server 100, the list sending unit 113 sends the distribution list to the client 200 in response to, for example, a request from the client 200 (Step S302).

Moreover, in the distribution server 100, the determination information generating unit 112 generates determination information (Step 2303). This operation is equivalent to, for example, the determination information generation operation explained earlier. Then, in the distribution server 100, the determination information sending unit 114 sends the determination information to the client 200 in response to, for example, a request from the client 200 (Step S304).

In the client 200, the list receiving unit receives the distribution list, and the determination information receiving unit 212 receives the distribution information. Then, in the client 200, the determining unit 213 refers to the distribution list and the determination information, and determines the contents to be requested for transmission (Step S305). For example, when the distribution list illustrated in FIG. 3 is received, the determining unit 213 analyzes the received distribution list and obtains the URLs meant for obtaining the contents ContentA_{—1} to ContentA_4. Moreover, the determining unit 213 analyzes the received determination information and determines the transmittable contents from among the contents listed in the distribution list.

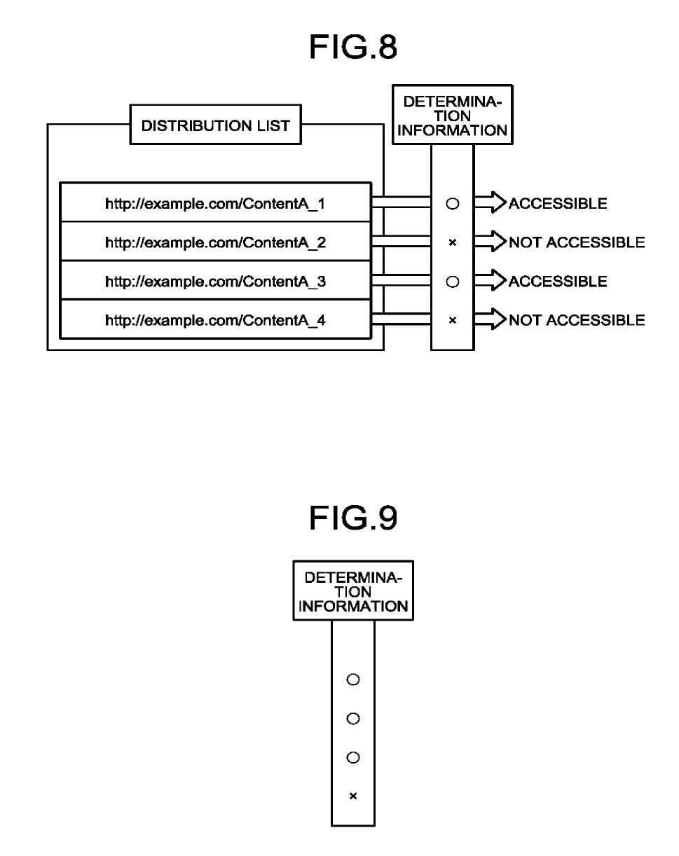

FIG. 8 is a diagram for explaining an example in which determination is performed with respect to the distribution list illustrated in FIG. 3 and performed using the determination information illustrated in FIG. 4. As illustrated in FIG. 8, when the URL meant for obtaining the content ContentA_1 listed in the distribution list is combined with the determination information corresponding to the content ContentA_1, the determining unit 213 can determine that the content ContentA_1 is transmittable (accessible). Similarly, the determining unit 213 can determine that the content ContentA_2 is not transmittable (not accessible).

Returning to the explanation with reference to FIG. 7, the request sending unit 214 sends, to the distribution server 100, a transmission request for sending the contents that are determined to be requested for transmission (Step S306). Then, in the distribution server 100, the contents sending unit 116 sends the requested contents to the client 200 (Step S307). In the client 200, the contents receiving unit 215 receives the contents, and the reproducing unit 216 reproduces the received contents (Step S308).

Subsequently, assume that the content ContentA_2 changes to the distributable state. In that case, in the distribution server 100, the detecting unit 101 detects that the content ContentA_2 has changed to the distributable state. Thus, the determination information generating unit 112 generates determination information that is updated according to the detection result (Step S309).

FIG. 9 is a diagram illustrating an example of the updated determination information. As illustrated in FIG. 9, the determination information generating unit 112 updates the determination information corresponding to the content ContentA_2 from “×” to “∘”. The updated determination information is set to be distributable via the network 300.

Returning to the explanation with reference to FIG. 7, for example, in response to a request from the client 200, the determination information sending unit 114 in the distribution server 100 sends the updated determination information to the client 200 (Step S310). The subsequent operations performed at Steps S311 to S314 are identical to the operations performed at Steps S305 to S308, respectively.

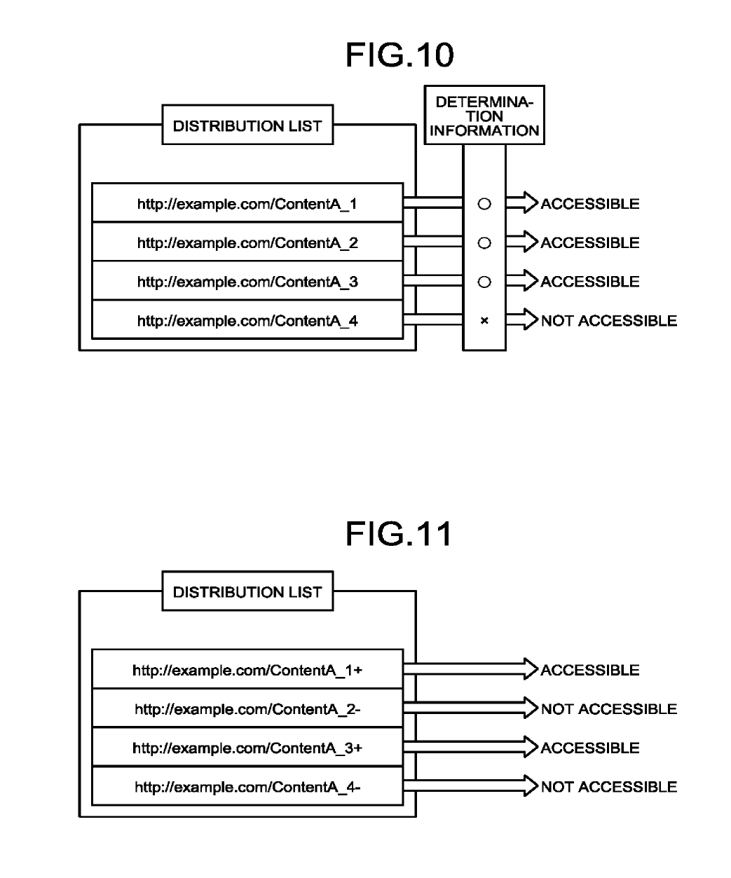

FIG. 10 is a diagram for explaining an example in which determination with respect to the distribution list illustrated in FIG. 3 is performed using the determination information illustrated in FIG. 9. As illustrated in FIG. 10, the determining unit 212 can determine that the content ContentA_2 has changed to the transmittable (accessible) state.

In this way, when the content ContentA_2 changes to the distributable state, the client 200 need not re-obtain the distribution list and can obtain the latest state of each content lust by applying the updated determination information with respect to the already-received distribution list.

As described above, in the communication system according to the embodiment, without having to re-obtain and reanalyze the information indicating the distribution targets (i.e., the distribution list), information equivalent to the latest distribution list can be efficiently obtained and analyzed.

### FIRST MODIFICATION EXAMPLE

A distribution list can include the determination information at the point of time of generation of the distribution list. For example, the list generating unit 111 can generate the distribution list in which determination information is associated to the identification information such as the URL of each content.

FIG. 11 is a diagram illustrating an exemplary data structure of the distribution list according to the first modification example and is a diagram for explaining an example of performing determination using the distribution list. In the example illustrated in FIG. 11, the “+” and “−” signs written on the right-hand side of the URLs indicate the determination information. For example, the “+” sign indicates that the corresponding content is transmittable, and the “−” sign indicates that the corresponding content is not transmittable. With such a configuration, by referring only to the initially-received distribution list, the client 200 can determine the transmittable contents at that point of time.

When the determination information is updated, the updated determination information is generated in an identical manner to that in the embodiment described above, and is sent to the client 200.

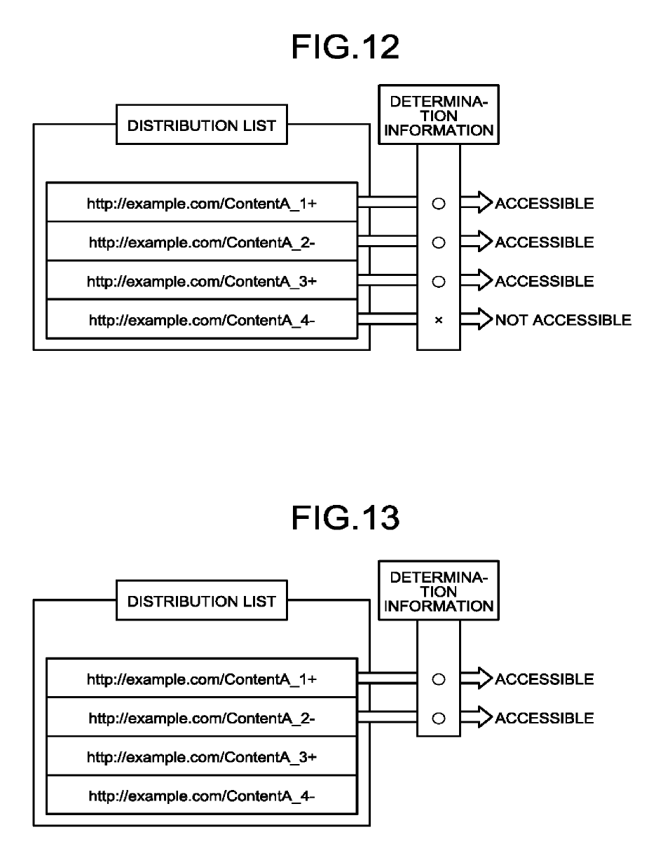

FIG. 12 is a diagram for explaining an example in which determination with respect to the distribution list illustrated in FIG. 11 is performed using the updated determination information. In FIG. 12 is illustrated an example in which the content ContentA_2 changes to the distributable state by referring to the initially-received distribution list and the updated determination information, the determining unit 213 can determine that the content ContentA_2 has changed to the transmittable (accessible) State.

### SECOND MODIFICATION EXAMPLE

The determination information need not be sent with respect to all contents listed in the distribution list, and can be sent with respect to only some of the contents. For example, the determination information generating unit 112 can generate determination information with respect to only those contents for which the client 200 has issued a transmission request, and the determination information sending unit 114 can send the generated determination information to the client 200. Herein, the determination information sending unit 114 can send, from among the already-generated determination information, only the determination information requested by the client 200.

FIG. 13 is a diagram for explaining an example in which only some of the determination information is sent and determination is accordingly performed. In FIG. 13 is illustrated an example in which the determination information corresponding to only the contents ContentA_1 and ContentA_2 is sent. Herein, regarding the contents for which the corresponding determination information is to be sent; the decision can be taken when, for example, the client 200 sends the identification information (URLs) of the contents to be requested for transmission.

Meanwhile, in FIG. 13 is illustrated an example in which the distribution list according to the first modification example is used. Alternatively, the second modification example is applicable also with respect to the distribution list according to the embodiment described above (FIG. 4).

### THIRD MODIFICATION EXAMPLE

Regarding the distribution list too, the configuration can be such that, instead of sending the entire distribution list, only some part of the distribution list is sent. For example, from among the already-generated distribution list, the list sending unit 113 can send only the partial distribution list as requested by the client 200.

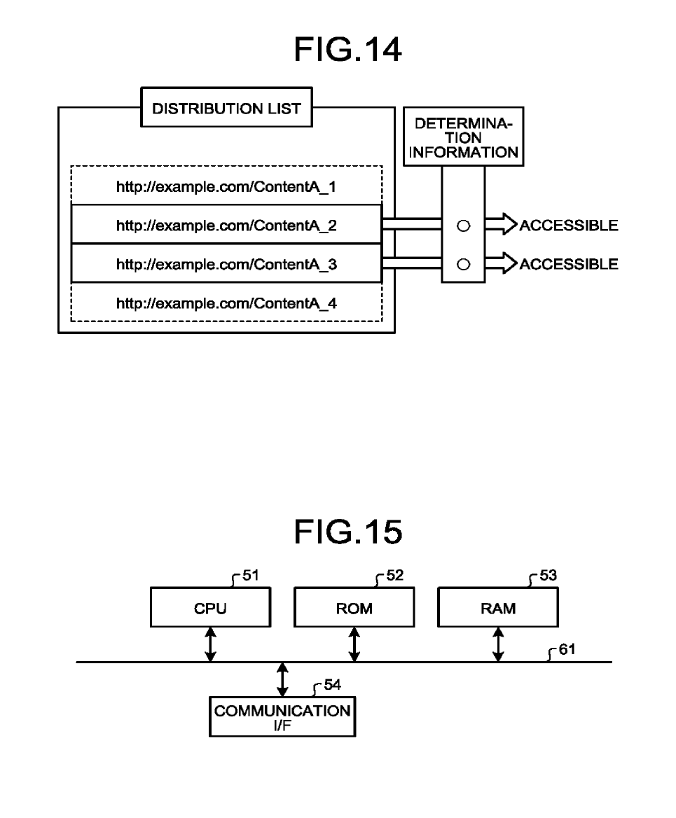

FIG. 14 is a diagram for explaining an example in which only some part of the distribution list is sent and determination is accordingly performed. In FIG. 14 is illustrated an example in which, from the distribution list including the contents ContentA_1 to ContentA_4, a distribution list including only the contents ContentA_2 and ContentA_3 is sent.

For example, the client 200 sends, to the distribution server 100, a request to include information enabling identification of the contents listed in the distribution list. The information enabling identification of the contents represents, for example, information enabling identification of the start timing and the end timing of the desired section to be distributed from among the contents representing time-series data. The distribution server 100 refers to such information and decides on the identification information about the contents to be listed in the distribution list, and generates a distribution list including the decided identification information.

Meanwhile, in FIG. 14 is illustrated an example in which the distribution list according to the embodiment described above (FIG. 4) is used. Alternatively, the third modification example is applicable also with respect to the distribution list according to the first modification example (FIG. 11).

Explained below with reference to FIG. 15 is a hardware configuration of the devices (the distribution server and the client) according to the embodiment described above. FIG. 15 is an explanatory diagram of an exemplary hardware configuration of the devices according to the embodiment described above.

The devices according to the embodiment described above include a control device such as a CPU 51; memory devices such as a read only memory (ROM) 52 and a RAM 53; a communication I/F 54 that performs communication by establishing connection with a network; and a bus 61 that connects the constituent elements to each other.

A computer program executed in the devices according to the embodiment described above is stored in advance in the ROM 52.

Alternatively, the computer program executed in the devices according to the embodiment described above can be recorded as an installable file or an executable file in computer-readable recording medium such as a compact disk read only memory (CD-ROM), a flexible disk (ED), a compact disk recordable (CD-R), or a digital versatile disk (DVD); and can be provided as a computer program product.

Still alternatively, the computer program executed in the devices according to the embodiment described above can be stored in a downloadable manner in a computer connected to a network such as the Internet. Still alternatively, the computer program executed in the devices according to the embodiment described above can be distributed via a network such as the Internet.

The computer program executed in the devices according to the embodiment described above can make the computer function as the constituent elements of the devices described above. In the computer, the CPU 51 can execute the computer program after reading it from a computer-readable memory medium into a main memory device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A transmission device comprising:
a first sending unit configured to send, to a receiving device, one or more pieces of identification information identifying one or more pieces of transmission data; and
a second sending unit configured to send, to the receiving device, determination information meant for determining whether or not to request transmission of the transmission data identified by the identification information.

2. The device according to claim 1, further comprising a generating unit configured to
generate the determination information which, when the transmission data is transmittable, indicates that the transmission data is transmittable, and
generate the determination information which, when the transmission data is not transmittable, indicates that the transmission data is not transmittable, wherein
the second sending unit sends the generated determination information to the receiving device.

3. The device according to claim 1, wherein the sending unit sends the identification information to the receiving device before start of transmission of the transmission data.

4. The device according to claim 1, wherein the first sending unit sends, to the receiving device, the identification information having the determination information associated thereto.

5. The device according to claim 1, wherein the first sending unit sends, to the receiving device, a distribution list that includes the identification information identifying the transmission data which is a transmission target.

6. The device according to claim 1, wherein
the first sending unit sends a plurality of pieces of identification information identifying a plurality of pieces of transmission data, and
the plurality of pieces of transmission data represents time-series data in which chronological sequence is fixed.

7. The device according to claim 1, further comprising:
a request receiving unit configured to receive, from the receiving device, a transmission request for sending the transmission data that has been determined to be requested for transmission based on the determination information; and
a third sending unit configured to send, to the receiving device, the transmission data as requested in the transmission request.

8. A receiving device comprising:
a first receiving unit configured to receive, from a transmission device, one or more pieces of identification information identifying one or more pieces of transmission data;
a second receiving unit configured to receive, from the transmission device, determination information meant for determining whether or not to request transmission of the transmission data identified by the identification information; and
a determining unit configured to, based on the determination information, determine the transmission data to be requested for transmission from among the one or more pieces of transmission data.

9. The device according to claim 8, wherein the first receiving unit receives the identification information from the transmission device before the transmission device starts transmission of the transmission data.

10. The device according to claim 8, wherein the first receiving unit receives, from the transmission device, the identification information having the determination information associated thereto.

11. The device according to claim 8, wherein the first receiving unit receives, from the transmission device, a distribution list including the identification information identifying the transmission data which is a transmission target.

12. The device according to claim 8, wherein
the first receiving unit receives a plurality of identification information identifying a plurality of pieces of transmission data, and
the plurality of pieces of transmission data represents time-series data in which chronological sequence is fixed.

13. The device according to claim 8, further comprising:
a request sending unit configured to send transmission request for sending the transmission data determined to be requested for transmission; and
a third receiving unit configured to receive the transmission data sent in response to the transmission request.

14. A communication system comprising:
a transmission device; and
a receiving device, wherein
the transmission device includes
a first sending unit configured to send, to the receiving device, one or more pieces of identification information identifying one or more pieces of transmission data, and
a second sending unit configured to send, to the receiving device, determination information meant for determining whether or not to request transmission of the transmission data identified by the identification information, and
the receiving device includes
a first receiving unit configured to receive, from the transmission device, one or more pieces of identification information identifying one or more pieces of transmission data,
a second receiving unit configured to receive, from the transmission device, determination information meant for determining whether or not to request transmission of the transmission data identified by the identification information, and
a determining unit configured to, based on the determination information, determine the transmission data to be requested for transmission from among the one or more pieces of transmission data.

15. A computer program product comprising a computer readable medium including programmed instructions, the instructions, when executed by a computer, causing the computer to function as:
a first sending unit configured to send, to a receiving device, one or more pieces of identification information identifying one or more pieces of transmission data; and
a second sending unit configured to send, to the receiving device, determination information meant for determining whether or not to request transmission of the transmission data identified by the identification information.
